(19) United States
(12) Patent Application Publication
(10) Pub. No.: US 2019/0059238 A1
(43) Pub. Date: Feb. 28, 2019

(54) PLANTING DEVICE

(71) Applicant: OPCOM INC., New Taipei City (TW)

(72) Inventor: Chih-Yu Ting, New Taipei City (TW)

(21) Appl. No.: 16/105,965

(22) Filed: Aug. 20, 2018

Related U.S. Application Data
(60) Provisional application No. 62/550,050, filed on Aug. 25, 2017.
(60) Provisional application No. 62/550,053, filed on Aug. 25, 2017.

(51) Int. Cl. A01G 7/04; F21V 23/04; F21V 23/00; A01G 9/02; A01G 9/24

(52) U.S. Cl. CPC A01G 7/045; F21V 23/04; F21V 23/003; F21Y 2115/10; A01G 9/247; A01G 9/246; A01G 9/028

(57) ABSTRACT

A planting device is provided. The planting device includes a base, at least one supporter, a light module and a fan. The base includes a planting slot. One end of the supporter connects to the base. The light module has a plurality of first light units and a plurality of second light units, each first light unit 131a and each second light unit have a first color light with a first wavelength and a second color light with a second wavelength, and the first wavelength and the second wavelength are difference, the plants receive the first color light of the first light units and/or the second color light of the second light units to generate gas. The fan corresponds to the plants for blowing the gas, and the other end of the supporter connects to the light module or the fan.

### CROSS REFERENCE TO RELATED APPLICATIONS

This application claims the benefit of U.S. Provisional Application No. 62/550,050, which was filed on Aug. 25, 2017, and the benefit of U.S. Provisional Application No. 62/550,053, which was filed on Aug. 25, 2017, and is incorporated herein by reference.

### BACKGROUND OF THE INVENTION

### 1. Field of the Invention

The invention relates in general to planting device, and more particularly to the planting device with at least two light elements and a fan.

### 2. Description of the Prior Art

Currently, when the user plants any kinds of plants, the user sets some lights disposed on a supporter or a frame to around the plants for emitting the plants.

During the growth of the plants, the plants need different light source for growing, such as different color light or different light wavelength. Therefore, the user needs to bus many light devices, and each of them have different color lights.

It needs a lot of spaces for storing the light devices and needs greater space to set many light devices around the plants, and the light devices are only for planting, therefore, the availability of the light devices is very low, and the light devices may not save the space and cost.

Convention plants planted around house, at home or in office is widely used, and people plant plants for beautifying environment and high quality of life. And usually, the sizes and/or the types of the plants and the range of the planting due to the size of the house or the office. In addition, photosynthesis is performed by plants to generate fresh air, such as oxygen and/or phytoncide, but it always ignored by people. Therefore, if people need to blow with fresh air from plants, it may need to the forest with many kinds of plants or a certain number or amount of plants planted at home or office to generate enough fresh air for breathing.

Therefore, it is in need to provide a planting device for planting many kinds of plants to generate fresh air to discharge to environment to exchange the air of environment for fresh air.

### SUMMARY OF THE INVENTION

The disclosure is directed to a planting device. The planting device has at least two light elements with different wavelengths and a fan.

According to one aspect of the present disclosure, a planting device is provided. The planting device includes a base, at least one supporter, a light module and a fan. The base includes a planting slot. One end of the supporter connects to the base. The light module has a plurality of first light units and a plurality of second light units, each first light unit and each second light unit have a first color light with a first wavelength and a second color light with a second wavelength, and the first wavelength and the second wavelength are difference, the plants receive the first color light of the first light units and/or the second color light of the second light units to generate gas. The fan corresponds to the plants for blowing the gas, and the other end of the supporter connects to the light module or the fan.

By the features described above, the present invention provides a planting device, the planting device provides a fan and at least two light units, such as the first light units and the second light units of the light module, and the first light units has the first color light with the first wavelength and the second light units has the second color light with the second wavelength, and the planting device switch the first light units and/or the second light units to emit or close the first color light and the second color light and even at the same time as necessary, and the light module with different the light sources is not only provided to grow the plants but also provided as a reading/night lamp. The light module connects to the supporter to save space and may further be switched or rotated with the supporter easily for providing the different light sources as necessary. Furthermore, when the light module provides the light source to the plants, the plants performs photosynthesis to generate gas and the gas is transferred everywhere in accordance with the fan to achieve exchanging gas for air. Therefore, the planting device may provide exchanged air and cleaning air function and at least two light functions to grow the plants or be as a reading/night lamp to increase availability.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A to FIG. 1C are views showing a planting device according to one embodiment of the present invention.

FIG. 2A to 2C are views showing a planting device according to another embodiment of the present invention.

FIG. 3A to 3B are views showing a planting device according to another embodiment of the present invention.

### DETAILED DESCRIPTION

Preferred embodiments are disclosed below for elaborating the invention. Various lengths, such as optical focus lengths or distances, of a plurality of micro lenses are applied on a plurality of detecting pixels, such that in an autofocus process, the time consumption can be reduced, and the accuracy can be improved. The following embodiments are for the purpose of elaboration only, not for limiting the scope of protection of the invention. Besides, secondary elements are omitted in the following embodiments to highlight the technical features of the invention.

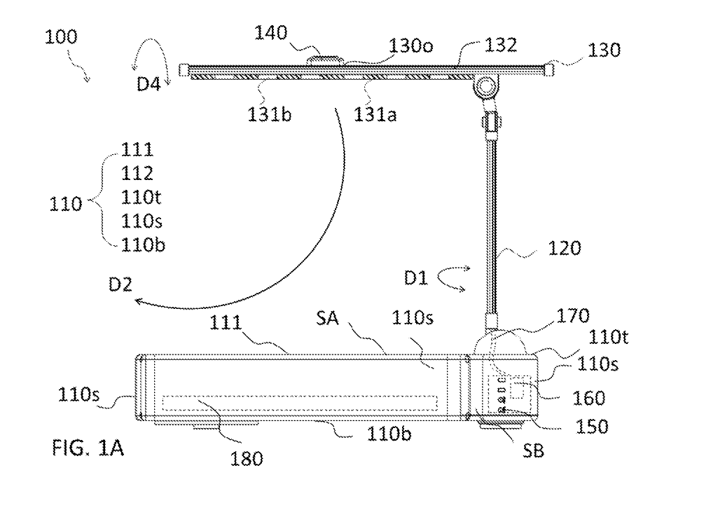

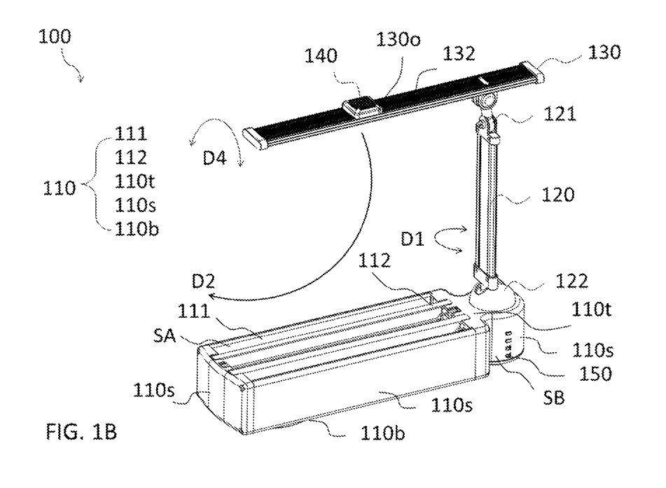

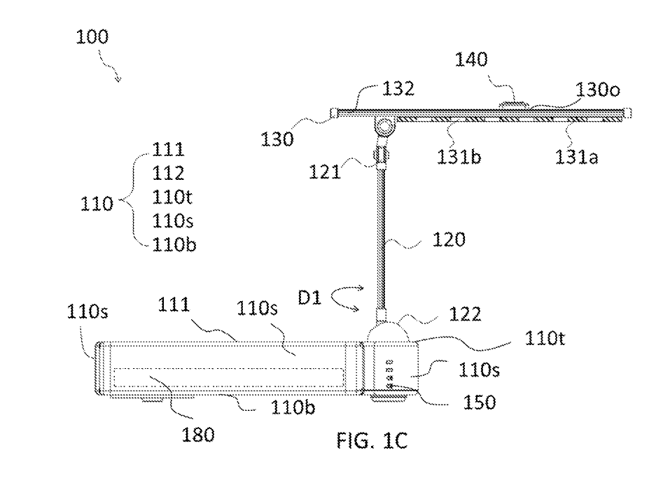

Reference is now made to FIG. 1A to FIG. 1C, views showing a planting device according to one embodiment of the present invention. As shown in FIG. 1A to FIG. 1C, a planting device 100 includes a base 110, at least one supporter 120, a light module 130 and a fan 140. One end of the supporter 120 connects to the base 110. The other end of the supporter 120 connects to the light module 130 or the fan 140. The planting device 100 further includes a switch 150, a controller 160 and a wire 170. Wherein, the controller 160 and the switch 150 may be disposed in the supporter 120, the base 110 or the light module 130, the wire 170 may electronically connect to the controller 160 and the switch 150. Here, the planting device 100 is exemplified to include the controller 160 and the switch 150 disposed in the base 110, and the other end of the supporter 120 connects to the light module 130. In this embodiment, the planting device 100 may have a plurality of plants for planting the plants.

In an alternative embodiment, the base 110 includes a planting slot 111 and at least one planting board 112, and the plants are planted in the planting slot 111. The planting slot 111 may be separated to at least two areas for planting different size of the plants in accordance with the planting board 112. The planting slot 111 includes at least two spaces, such as a first space SA and a second space SB, for planting the plants and receiving the controller 160 and/or the switch 150. The first space SA may receive at least one planting block (no shown), such as a sponge or soils, and the plants are further planted in the sponge or soils, but the present invention is not limited to the embodiments explained above. The second space SB of the planting slot 111 is near the first space SA, for example, the second space SB may receive the controller 160 and the switch 150.

In an alternative embodiment, the light module 130 includes a plurality of first light units 131a and a plurality of second light units 131b. Each first light unit 131a and each second light unit 131b have a first color light with a first wavelength and a second color light with a second wavelength, respectively. Wherein, the first wavelength and the second wavelength are different. Furthermore, each first light unit 131a and each second light unit 131b may emit the first color light and the second color light. For example, the first wavelength and the second wavelength may be in a range from 380 to 750 nanometers and in a range from 620 to 750 nanometers, respectively. Therefore, the first color light and the second color light are white light and red light, respectively. In another current embodiment, it's a ratio between the first color light with the first wavelength and the second color light with second wavelength. Thus, the first color light and the second color light may have different colors. Here, the light module 130 is exemplified to include a plurality of the first light units 131a and a plurality of the second light units 131b, and the first color light of each first light unit 131a is white light and the second color light of each second light unit 131b is red light. In the current embodiment, the first light unit 131a and the second light unit 131b may be a light-emitting diode (LED), respectively, such as, the first light unit 131a may be a LED emitting white light and the second light unit 131b may be a LED emitting red light.

In another alternative embodiment, the light module 130 further includes a first base 132, and the first light units 131a and the second light units 131b are disposed on the first base 132 and on the same face of the first base 132, respectively. Each first light unit 131a and each second light unit 131b electronically connect with each other and are arranged in staggered relationship to one another. Furthermore, each first light unit 131a and each second light unit 131b may be arranged in the first base 132 in accordance with a pattern. In the current embodiment, the first base 132 may be a board or a tube, therefore, each first light unit 131a and each second light unit 131b may be arranged at the same face of the first base 132 of the light module 130. Here, the first light units 131a and the second light units 131b are exemplified to arrange the first base 132 which is a board. In another current embodiment, the first base 132 may further be a circuit board, and each first light unit 131a and each second light unit 131b electronically connect to the first base 132, respectively.

In another alternative embodiment, the light module 130 further includes a plurality of third light unit (no shown), and the third light units, the first light units 131a and the second light units 131b are arranged in staggered relationship with each other on the same face of the first base 132. The third light unit has a third color light with a third wavelength, such as, the third wavelength may be in a range from 450 to 495 nanometers, and the third color light may be blue light, but the present invention is not limited to the embodiments explained above.

In the current embodiment, the supporter 120 further includes at least one rotating unit. Here, the supporter 120 is exemplified to include two rotating units 121, 122. One end of the supporter 120 connects to the base 110, and the other end of the supporter 120 connects to the light module 130. The rotating units 121, 122 may further be disposed between the supporter 120 and the base 110 and/or between the supporter 120 and the light module 130. The rotating units 121, 122 may be ball joint assemblies or hinge assemblies, and the rotating units 121, 122 may be a rotating structure with at least two rotating directions, but the present invention is not limited to the embodiments explained above.

In the current embodiment, the wire 170 is further disposed in the supporter 120 and electronically connects to the controller 160, the switch 150, the first light units 131a and the second light units 131b. Furthermore, one end of the wire 170 connects to the controller 160 and the switch 150, and the other end of the wire 170 connects to the first base 132 of the light module 130 and /or the first light units 131a and the second light units 131b. The controller 160 and the switch 150 transfer a controlling signal and/or a switch signal to the first light units 131a and the second light units 131b in accordance with the wire 170 to control each first light unit 131a and/or each second light unit 131b to emit the first color light and the second color light, respectively. Therefore, the first light units 131a and the second light units 131b are switched in accordance with the switch 150, and the controlling signal or the switch signal may be a voltage value, respectively, but the present invention is not limited to the embodiments explained above. The controller 160 may be constructed by a circuit board, control unit, electronic elements (no shown), and the switch 150 and the controller 160 electronically connect with each other and are disposed in the circuit board, but the present invention is not limited to the embodiments explained above.

In another current embodiment, the switch 150 may include at least one button, the button may be disposed in the base 110, the supporter 120 or the light module 130 to switch 150 the first light units 131a emitting the first color light or the second light units 131b emitting the second color light. Here, the switch 150 is exemplified to include four buttons disposed in the base 110.

In another current embodiment, the controller 160 may include a plurality of switch modes which is performed by application or software. The controller 160 controls the switch 150 to switch the first light units 131a emitting the first color light or the second light units 131b emitting the second color light in accordance with the user setting a plurality of parameters of the switch modes. For example, during 24 hours of a day, in a switch mode, the first light units 131a may be set to emit the first color light from 0 to Nth hours and the second light units 131b may be set to emit the second color light from Nth to twenty fourth hours; or in another switch mode, the first light units 131a may be set to emit the first color light at every M hour, and the second light units 131b may be set to emit the second color light at every 0 hour and/or the first light units 131a and the second light units 131b may be set to emit the first color light and the second color light at the same time at every P hour and/or to close the first color light and the second color light at the same time at every Q hour. Wherein, the value of M, N, O, P and Q may be the same or different and are greater than 0.

In the current embodiment, the first space SA and the second space SB may be formed form four side faces 110s and a bottom face 110b. In another current embodiment, the first space SA and the second space SB may be formed from a recess into the base 110. A board or a wall is disposed between the first space SA and the second space SB, and the second space SB is further formed a top face 110t, side faces 110s and the bottom face 110b to be a close room to achieve waterproof. The plants may be disposed and planted into the first space SA, and the water received into the first space SA may not invade to the second space SB to damage the controller 160 and the switch 150. Therefore, the electronic elements (no shown) may be disposed in the second space SB to provide a plurality of functions to increase operability of the planting device 100.

As shown in FIG. 1A to FIG. 1C, in an alternative embodiment, the light module 130 is selectively corresponding to the planting slot 111 of the base 110 in accordance with the rotating unit 122. Furthermore, if the plants need to be emitted the light, the light module 130 may be turned or rotated to correspond to the planting slot 111 of the base 110 by the supporter 120, and the first light units 131a and the second light units 131b emit to the plants. When the light module 130 to be another function, such as a reading/ night lamp, the light module 130 may be turned from a position which corresponds to the planting slot 111 to another position in accordance with the rotating unit 122, therefore, the light module 130 is not corresponding to the planting slot 111, and the user may read in accordance with the light module 130. In another current embodiment, the light module 130 may be turned or rotated along a first direction D1 to not correspond to the planting slot 111.

In another alternative embodiment, the light module 130 includes a rotated detecting unit (no shown); the rotated detecting unit is disposed in the supporter 120, the base 110 or the light module 130. Furthermore, the rotated detecting unit connects to the controller 160, and the controller 160 may set an initial position which is determine that the light module 130 corresponds to the planting slot 111 or the light module 130 is above the planting slot 111; or a orthogonal projection or the light module 130 overlaps the planting slot 111. When the supporter 120 is relatively movable to the base 110 to move the light module 130, the rotated detecting unit detects an angle between the light module 130 and the initial position. The controller 160 determines the angle is smaller than or equal to a determined angle, the controller 160 controls the switch 150 to switch the second light units 131b to emit the second color light. The controller 160 determines the angle is greater than the determined angle, and the controller 160 controls the switch 150 to switch the first light unit 131a to emit the first color light. The angle may be a range or a value, but the present invention is not limited to the embodiments explained above. For example, if the determined angle is 30 degree, and the light module 130 is turned or rotated and the rotated detecting unit detects the angle is 45 degree being greater than the determined angle, the light module 130 is not corresponding to the planting slot 111 and the controller 160 controls the switch 150 to switch the first light units 131a to emit the first color light to provide the user to read or to be a lamp. Therefore, the light module 130 or the supporter 120 may be turned, rotated or switched as necessary, and when the light module 130 or the supporter 120 is turned, rotated or switched, the first light units 131a and/or the second light units 131b may be switched. Meanwhile, the rotated detecting unit detects the angle between the light module 130 and the initial position, and the controller 160 determines the angle is smaller than, greater than or equal to the determined angle to switch the first light units 131a and/or the second light units 131b to emit the first color light and/or the second color light, and even switch the first light units 131a and the second light units 131b to emit the first color light and the second color light at the same time as necessary, but the present invention is not limited to the embodiments explained above.

Therefore, whether the light module 130 corresponds to the planting slot 111 of the base 110, the controller 160 may selectively switch the switch modes. For example, during one day, the controller 160 may set a period of 8 am to 6 pm to switch the second light units 131b to emit the second color light to emit the plants of the planting slot 111 of the base 110. The controller 160 may set a period of 6 pm to 0 am to switch the first light units 131a to emit the first color light, and set a period of 0 am to 8 am to switch the first light units 131a and the second light units 131b to be closed at the same time, but the present invention is not limited to the embodiments explained above.

In an alternative embodiment, when the plants are planted into the planting slot 111 of the base 110, the light module 130 corresponds to the plants and the first light units 131a emit the first color light, and the plants receive the first color light of the first light units 131a to generate gas, such as oxygen.

In another alternative embodiment, the light module 130 corresponds to the plants, and the first light units 131a emit the first color light and the second light units 131b emit the second color light, and the plants receive the first color light and the second color light to generate gas.

The fan 140 corresponds to the plants for blowing the gas, furthermore, the fan 140 provides wind source to blowing the gas from the plants. The light module 130 forms a first opening 130o disposed between two corresponding faces of the light module 130, and the fan 140 is located at the first opening 130o . The first light units 131a and the second light units 131b arrange with each other and are disposed around the fan 140. The fan 140, the first light units 131a and the second light units 131b are further disposed on the same face of the light module 130 and correspond to the planting slot 111 of the base 110. The fan 140, for example, is an exhaust fan or a replacement ventilation fan. The first base 132 is rotated along a fourth direction D4 to make the first light units 131a, the second light units 131b and the fan 140 to correspond to the plants of the planting slot 111 of the base 110. Furthermore, the light module 130 and the fan 140 provide light source and wind source in a second direction D2 to the plants.

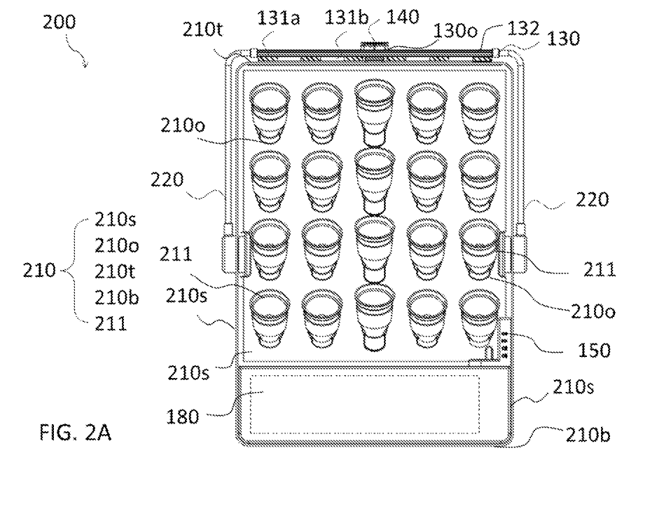

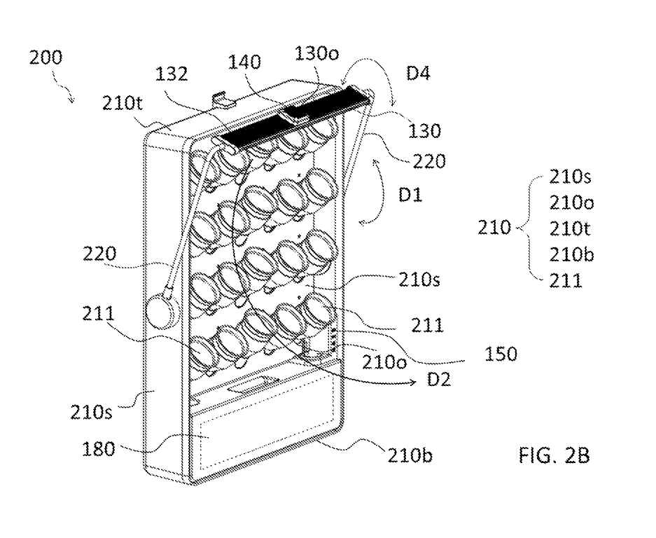

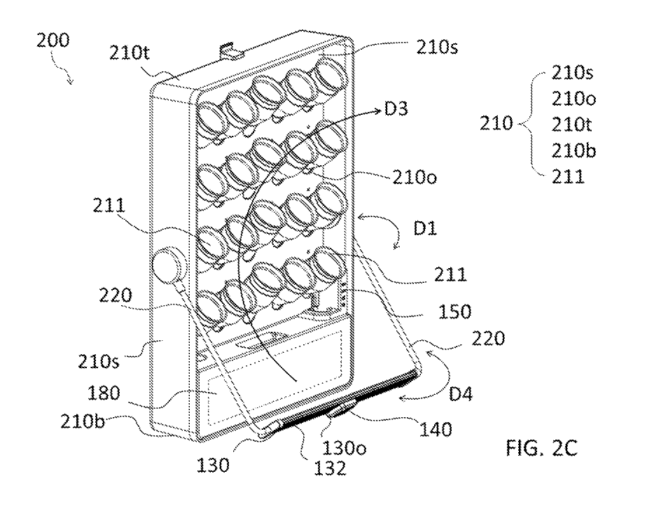

Reference is now made to FIG. 2A to FIG. 2C, views showing a planting device according to another embodiment of the present invention. As shown in FIG. 1A to FIG. 1C and FIG. 2A to FIG. 2C, the planting device 200 of the present invention of FIG. 2A to FIG. 2C is similar to the planting device 100 of FIG. 1A to FIG. 1C, and the same element designations and symbols are used in the present embodiment. The difference between the planting device 200 of FIG. 2A to FIG. 2C and the planting device 100 of FIG. 1A to FIG. 1C is that the base 210 of the planting device 200 further includes a plurality of the planting slots 211, and the planting device 200 further includes two supporters 220. One end of each supporter 220 connects to two corresponding ends of the base 210, respectively, two corresponding ends of the light module 130 connects to the other end of each supporter 220, respectively.

As shown in FIG. 2A to FIG. 2C, the planting device 200 includes the fan 140, such as an exhaust fan. The supporters 220 are relatively movable to the base 210 in the first direction D1 to move the light module 130 to locate in a first position, a second position, a third position or between the second position and the third position. When the light module 130 is located in the second position, the third position or between the second position and the third position in accordance with the supporters 220, the light module 130 and the fan 140 are corresponding to the planting slot 211, respectively. Furthermore, the light module 130 and the fan 140 provide light source and wind source in a second direction D2 or a third direction D3 to the plants.

When the light module 130 of the planting device 200 is in the first position, the light module 130 may be in a storage status. When the light module 130 of the planting device 200 moves from the first position to the second position, the first base 132 is rotated along a fourth direction D4 to make the first light units 131a, the second light units 131b and the fan 140 to correspond to the plants of the planting slot 211 of the base 210, and the plans performs photosynthesis to generate gas, such as oxygen in accordance with the light source provided from the first light units 131a and/or the second light units 131b. Meanwhile, the fan 140 blows the gas from the plants to everywhere in the second direction D2 to exchange with the air for providing fresh air or gas. When the supporters 220 of the planting device 200 are relatively movable to the base 210 along the first direction D1 to move the light module 130 to move from the second position to the third position, the first base 132 of the light module 130 rotates along the fourth direction D4 to make the first light units 131a, the second light units 131b and the fan 140 to correspond to the plants to generate the gas. And then, the gas may be blown everywhere in accordance with the fan 140.

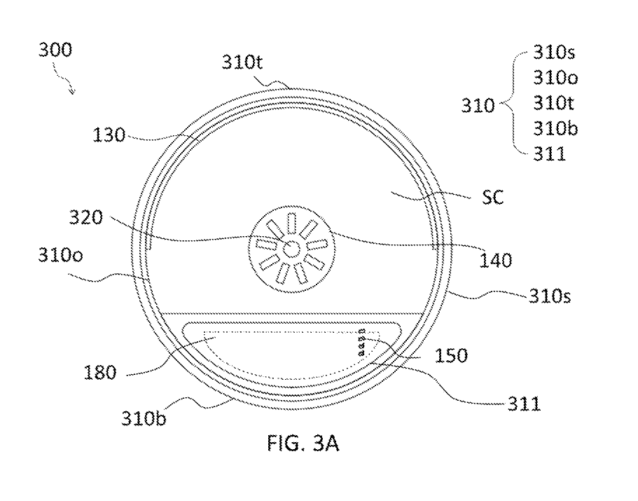

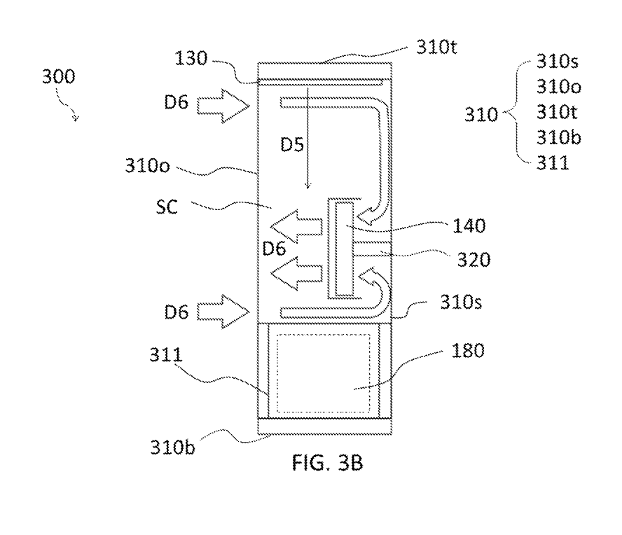

Reference is now made to FIG. 3A to FIG. 3B, views showing a planting device according to another embodiment of the present invention. As shown in FIG. 1A to FIG. 1C and FIG. 3A to FIG. 3B, the planting device 300 of the present invention of FIG. 3A to FIG. 3B is similar to the planting device 100 of FIG. 1A to FIG. 1C, and the same element designations and symbols are used in the present embodiment. The difference between the planting device 300 of FIG. 3A to FIG. 3B and the planting device 100 of FIG. 1A to FIG. 1C is that the base 310 of the planting device 300 further includes at least two faces 310s, a top face 310t and a bottom face 310b to form a third space SC and a third opening 3100 connect with each other. The planting device 300 includes the planting slot 311, the supporter 320, the light module 130 and the fan 140 received in the third space SC, the light module 130 and the planting slot 311 are corresponding to disposed in the top face 310t and the bottom face 310b, the other end of the supporter 320 connects to the fan 140 corresponding to the third opening 310o. The fan 140 provides the wind source to blow the gas from the plants to the third opening 310o, and the planting device 300 is in an air cycle status in accordance with the fan 140 and the third opening 310o. In the current embodiment, the third opening 310o corresponds to the face 310s, and the top face 310t and the bottom face 310b forms a round wall to connect to the face 310s and the third opening 310o.

In an alternative embodiment, the light module 130 is corresponding to the planting slot 311 in a fifth direction D5, and the fan 140 is corresponding to the planting slot 311 in a sixth direction D6, and an angle between the fifth direction D5 and the sixth direction D6, such as 90 degree, therefore, the fifth direction D5 and the sixth direction D6 are perpendicular.

As shown in FIG. 1A to FIG. 1C, FIG. 2A to FIG. 2C and FIG. 3A to FIG. 3B, the planting device 100, 200, 300 further includes a water supply 180 disposed in the base 110, 210, 310 of the planting device 100, 200, 300. The water supply 180 may include a water tank (no shown) supplying water source and provide a water recycle system, and the planting slot 111, 211, 311 may connect to the water tank in accordance with a pipe, the plants may grow in accordance with the water source of the water tank. The water supply 180 further includes an air pump element (no shown) for providing air to the water source, and the plants may absorb the water source and air to grow well, but the present invention is not limited to the embodiments explained above.

According to the planting device 100, 200, 300 provides a fan 140 and at least two light units, such as the first light units 131a and the second light units 131b of the light module 130, and the first light units 131a has the first color light with the first wavelength and the second light units 131b has the second color light with the second wavelength, and the planting device 100, 200, 300 switches the first light units 131a and/or the second light units 131b to emit or close the first color light and the second color light and even at the same time as necessary, and the light module 130 with different the light sources is not only provided to grow the plants but also provided as a reading/night lamp. The light module 130 connects to the supporter 120, 220, 320 to save space and may further be switched or rotated with the supporter 120, 220, 320 easily for providing the different light sources as necessary. Furthermore, when the light module 130 provides the light source to the plants, the plants performs photosynthesis to generate gas and the gas is transferred everywhere in accordance with the fan 140 to achieve exchanging gas for air. Therefore, the planting device 100, 200, 300 may provide exchanged air and cleaning air function and at least two light function to grow the plants or be as a reading/night lamp to increase availability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A planting device for planting plants, comprising:
a base comprising a planting slot;
at least one supporter, one end of the supporter connecting to the base;
a light module having a plurality of first light units and a plurality of second light units, each first light unit and each second light unit having a first color light with a first wavelength and a second color light with a second wavelength, respectively, the first wavelength and the second wavelength being different, the plants receiving the first color light of the first light units and/or the second color light of the second light units to generate gas; and
a fan corresponding to the plants for blowing the gas, the other end of the supporter connecting to the light module or the fan.

2. The planting device of claim 1, wherein the light module forms a first opening disposed between two corresponding faces of the light module, and the fan is located at the first opening.

3. The planting device of claim 1, wherein the planting device further comprises two supporters, one end of each supporter connects to two corresponding ends of the base, respectively, and two corresponding ends of the light module connect to the other end of each supporter, respectively.

4. The planting device of claim 3, wherein the supporters are relatively movable to the base in a first direction to move the light module to locate in a first position, a second position, a third position or between the second position and the third position.

5. The planting device of claim 4, wherein when the light module is located in the second position, the third position or between the second position and the third position in accordance with the supporters, and the light module and the fan are corresponding to the planting slot, respectively.

6. The planting device of claim 1, wherein the first light units and the second light units arrange with each other and are disposed around the fan.

7. The planting device of claim 1, wherein the planting device further comprises a switch, and the first light units and the second light units are switched in accordance with the switch.

8. The planting device of claim 7, wherein the switch is disposed in the supporter, the base or the light module.

9. The planting device of claim 1, wherein the supporter comprises at least one rotating unit, and the light module is selectively corresponding to the planting slot of the base in accordance with the rotating unit.

10. The planting device of claim 1, wherein the first color light and the second color light are red light and white light, respectively.

11. The planting device of claim 1, wherein the planting device comprises a controller and a wire, the wire electronically connects to the controller, each first light unit and each second light unit, and the controller controls each first light unit and/or each second light unit to emit the first color light and the second color light, respectively.

12. The planting device of claim 1, wherein the planting device further comprises a water supply disposed in the base.

13. The planting device of claim 1, wherein the base comprises at least two faces, a top face and a bottom face to form a third space and a third opening connect with each other, the planting slot, the supporter, the light module and the fan are received in the third space, the light module and the planting slot are corresponding to be disposed in the top face and the bottom face, and the other end of the supporter connects to the fan corresponding to the third opening.

14. The planting device of claim 13, wherein the light module is corresponding to the planting slot in a fifth direction, the fan is corresponding to the planting slot in a sixth direction, and an angle is included between the fifth direction and the sixth direction.
